(19) United States
(12) Patent Application Publication
(10) Pub. No.: US 2006/0149905 A1
(43) Pub. Date: Jul. 6, 2006

(54) Service system for providing context information based on ubiquitous sensor network and method thereof

(76) Inventors: Seung-Min Park, Daejon (KR); Shung-Hwan Jo, Daejon (KR); Il-Gon Park, Daejon (KR); Chang-Min Shin, Daejon (KR); Jin-Won Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/262,042

(22) Filed: Oct. 27, 2005

(30) Foreign Application Priority Data
Dec. 16, 2004 (KR) 10-2004-0107231

(51) Int. Cl. G06F 13/28

(52) U.S. Cl. 711/141

(57) ABSTRACT

Provided is a service system for providing context information based on a ubiquitous sensor network and a method thereof. The context information providing service system includes: a sensing block for collecting context information of each user; an intermediating block for changing the user context information transmitted from the sensing block into a request to store the request in a context recognizing block, transmitting the request to the context recognizing block, and transmitting a service request to the context recognizing block; and a context recognizing block for storing context information of each user according to a context information storing request transmitted from the intermediating block, and providing a relevant service by using the user context information.

### FIELD OF THE INVENTION

The present invention relates to a service system for providing context information based on a ubiquitous sensor network and a method thereof; and, more particularly, to a context information providing service system based on a ubiquitous sensor network that can provide diverse and convenient services to a user with only minimum actions of the user by collecting context information of the user in real-time through the ubiquitous sensor network and providing optimized service to each user based on the context information, and a method thereof.

In the present invention, context information means all types of information specifying an existence such as a person, a place, and an object, connected with the interaction between a user and the object, and includes resource information generated from a tool having a calculation capability that the user uses, and peripheral information, which is changed based on the action of the user.

### DESCRIPTION OF RELATED ART

Generally, position information is the most important information in context information. A technology collecting the position information is represented by the Global Positioning System (GPS) or a mobile phone positioning technology based on base stations.

Among the conventional positioning systems, the GPS is a system acquiring position information of an object from 27 GPS satellites, which are revolving around the earth atmosphere in different orbits. The GPS acquires the position information by using signals received from a minimum of 4 satellites, but it works only when the object is in the outside. Since only a terminal having a receiver capable of receiving a GPS signal can acquire the position information, the acquired information cannot be used for other applications.

Another technology using base stations is based on a positioning characteristic of the Code Division Multiple Access (CDMA). It is possible to track the position of a user by using a CDMA terminal within the coverage of a base station. The method using the base stations has a merit that it can receive the positioning service with the conventional mobile phone, but the service cannot be provided in a shadow area which has a little large error range and does not have any base station.

The conventional positioning system, which is an inactive system only collecting sensing information through a individual sensors, cannot recognize the position in the inside, and has a shortcoming that precision is low.

Therefore, a service that can always provide exact position information and the united information including temperature, humidity, sound, luminosity, vibration collected from individual sensors is urgently required.

### SUMMARY OF THE INVENTION

It is, therefore, an object of the present invention to provide a context information providing service system based on a ubiquitous sensor network that can provide diverse and convenient services to a user with only minimum actions of the user by collecting context information of the user in real-time through the ubiquitous sensor network and providing optimized service to each user based on the context information, and a method thereof.

Other objects and advantages of the invention will be understood by the following description and become more apparent from the embodiments in accordance with the present invention, which is set forth hereinafter. It will be also apparent that objects and aspects of the invention can be embodied easily by the means defined in the claims and combinations thereof.

In accordance with an aspect of the present invention, there is provided a context information providing service system based on a ubiquitous sensor network, including: a sensing block for collecting context information of each user; an intermediating block for changing the user context information transmitted from the sensing block into a request to store the request in a context recognizing block, transmitting the request to the context recognizing block, and transmitting a service request transmitted from the user to the context recognizing block; and a context recognizing block for storing context information of each user according to a context information storing request transmitted from the intermediating block, and providing a relevant service by using the user context information that the context recognizing block stores according to the service request transmitted from the intermediating block.

In accordance with another aspect of the present invention, there is provided a context information providing service based on a ubiquitous sensor network including the steps of: a) collecting the context information of the user by using an ubiquitous network; b) storing the context information according to each user; and c) retrieving the context information of the user according to the service providing request coming from the user and providing a proper service.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a context information providing service system based on a ubiquitous sensor network in accordance with an embodiment of the present invention;

FIG. 2 is a block diagram illustrating sensor nodes of the context information providing service system based on a ubiquitous sensor network in accordance with an embodiment of the present invention;

FIG. 3 is a block diagram illustrating a context awareness middleware of the context information providing service system based on a ubiquitous sensor network in accordance with an embodiment of the present invention;

FIG. 4 is a block diagram illustrating a context awareness server of the context information providing service system based on a ubiquitous sensor network in accordance with an embodiment of the present invention;

FIG. 5 is a diagram showing a structure of a sensing-sensor of the context information providing service system based on a ubiquitous sensor network in accordance with an embodiment of the present invention; and

FIG. 6 is a block diagram showing a context information providing service method based on a ubiquitous sensor network in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on the prior art may blur the point of the present invention, the detailed description will not be provided herein. The preferred embodiments of the present invention will be described in detail hereinafter with reference to the attached drawings.

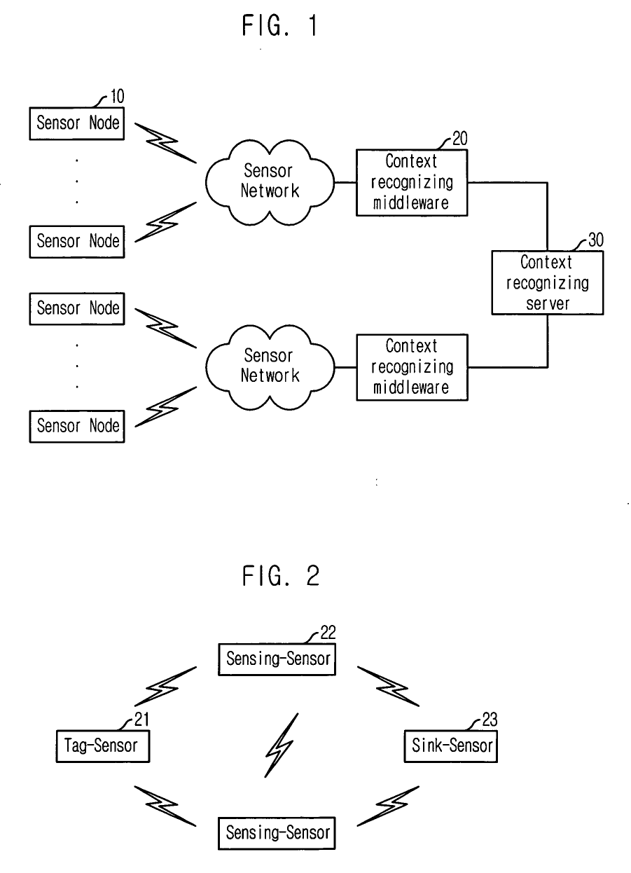

FIG. 1 is a block diagram showing a context information providing service system based on a ubiquitous sensor network in accordance with an embodiment of the present invention.

As shown in FIG. 1, the context information providing service system based on a ubiquitous sensor network includes sensor nodes 10, a context awareness middleware 20, and a context awareness server 30.

The sensor nodes 10 collect a change in the service environment of a user in real-time, i.e., context information of a place here the user is positioned such as position, temperature, humidity and a use of facility, and transmits the context information to the context awareness middleware 20 connected to a cable network through a self-formation of an ad-hoc routing.

The context awareness middleware 20 changes the user context information received from the sensor node 10 into a request to be stroed in the context awareness server 30, transmits the request to the context awareness server 30, and requests the service to the context awareness server 30 by checking a service preference, a condition of a device possessed by the user, and peripheral context information according to the service request transmitted from the user.

The context awareness server 30 stores the user context information according to the service context information storing request transmitted from the context awareness middleware 20, and provides the service according to the user context information stored in the context awareness server 30 according to the service request transmitted through the context awareness middleware 20.

The structure of the sensor nodes 10 will be described in detail hereinafter referring to FIG. 2.

FIG. 2 is a block diagram illustrating sensor nodes of the context information providing service system based on a ubiquitous sensor network in accordance with an embodiment of the present invention.

As shown in FIG. 2, the sensor nodes 10 of the context information providing service system based on a ubiquitous sensor network includes a tag-sensor 21, sensing-sensors 22, and a sink-sensor 23.

The tag-sensor 21 attached to a user or a device to provide a service senses the context information of the user in real-time.

The sensing-sensor 22 recognizes the position of the user by sensing the signal from the tag-sensor 21, and transmits active service data such as a service request from the user and inactive service data, which do not require a user intervention such as illegal invasion detection, through a routing.

The sink-sensor 23 collects the active service data and the inactive service data from a plurality of sensing-sensors 22, transmits the collected data to the context awareness middleware 20, and controls the context of the sensing-sensor.

The tag-sensor 21 is attached to the user or the device to provide a service, and can be embedded into the inside of the service device or mounted in the outside. The first step for providing the service through a context awareness is to recognize the position of the user. In the present invention, the position is recognized by calculating coordinates by using communication information between the tag-sensor 21 attached by the user and the sensing-sensor 22 attached in a building. That is, 2-way communication method that if the position information is transmitted to any tag-sensor 21 through wireless communication such as a radio frequency (RF) communication, a Zigbee communication, and an ultrawideBand communication in the sensing-sensor 22, the tag-sensor 21 calculates its own position coordinates based on the position information transmitted from more than three sensing-sensors, and have the context awareness server 30 recognize the position by transmitting the position information to the sensing-sensor 22, is used.

Adversely, the tag-sensor 21 transmits the signal to the sensing-sensor 22 existing in the outside, and the sensing-sensor 22 of the outside can calculate the position by using the signal. Herein, the position information of the tag-sensor 21 is one of the context information in the sensor network, and the definition of the context information in the present invention is as follows.

As described above, the context information in the present invention is all types of information specifying an existence such as a person, a place, and an object, connected with an interaction between the user and the object, and includes resource information generated from a tool having a calculation capability that the user uses, and peripheral information changed based on the action of the user.

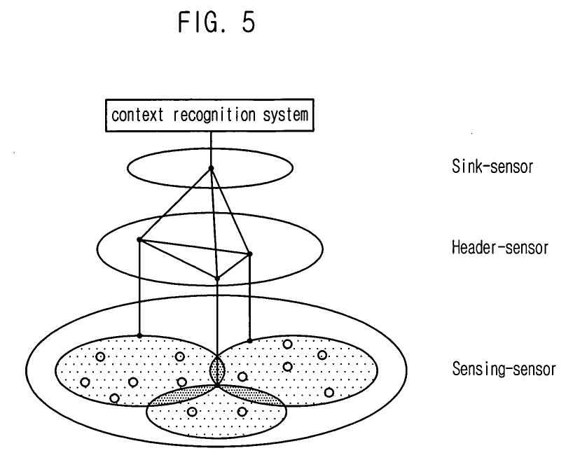

The context information including the position information of the tag-sensor 21 is transmitted to the context awareness server 30 through the sensing-sensor 22 formed of a network topology shown in FIG. 5. Herein, If possible, the sensing-sensor 22 can process the context information collected from the tag-sensor 21 without transmitting to the context awareness server 30.

Meanwhile, the network topology for transmitting the context information collected from the tag-sensor 21 can be divided into a sensing-sensor layer formed of only sensing-sensors for sensing the information required for a service, and a header-sensor layer separately summarizing the sensed information according to an area, a service, and a network. The header-sensor is selected among the sensing-sensors.

Meanwhile, the information summarized in the header-sensor is transmitted to the sink-sensor 23 performing a function of gateway which connects the sensor network and the context awareness system, i.e., the context awareness middleware and the context awareness server.

The sensors described above can freely communicate between layers of the same level through the wireless communication or a cable communication such as “RF”, “Zigbee” and “UWB”. The sensors can exchange a control message or data with each other by forming a group, and a new sensor can be added to or deleted from a formed group.

The header-sensor layer and a sink-sensor layer prevent traffic congestion of the sensor network by using a method that sets up a Time to Live (TTL) value as a number 1 to a packet including the context information. Herein, each sensor 22 can directly connected to the sink-sensor 23 without the header-sensor.

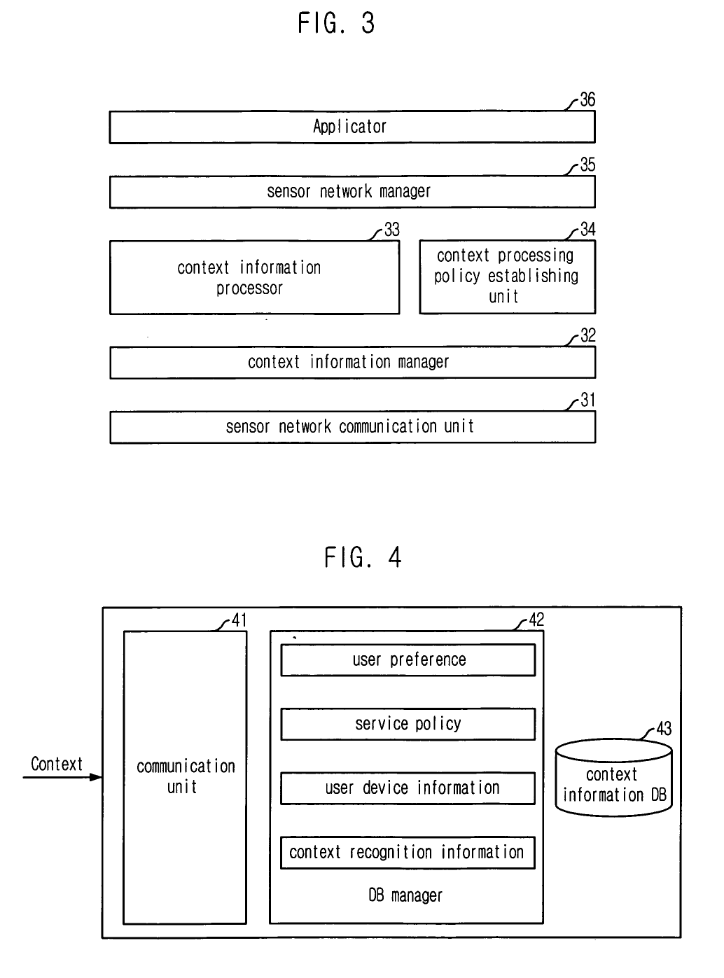

The structure of the context awareness middleware will be described in detail referring to FIG. 3.

FIG. 3 is a block diagram illustrating a context awareness middleware of the context information providing service system based on a ubiquitous sensor network in accordance with an embodiment of the present invention.

As shown in FIG. 3, the context awareness middleware 20 of the context information providing service system based on a ubiquitous sensor network of the present invention includes a sensor network communicating block 31, a context information managing block 32, a context process information setting block 34, a sensor network managing block 35, and an application block 36.

The sensor network communicating block 31 receives the context information coming from the sensor node 10 and the user service request.

The sensor network communicating block 31 additionally provides an authentication function determining whether to continuously provide the service of the user according to the user service request, and checks whether the service is properly provided to the user. If the check result comes out a failure, the sensor network communicating block 31 transmits the service again.

The context information managing block 32 stores the context information received through the sensor network communicating block 31 and the user service request in a database. Herein, the context information can be stored after being changed into an Extensible Markup Language (XML) form. The context information excluding the service request is transmitted to the context awareness server 30 through the sensor network communicating block 31. The service request is transmitted to the context information processing block 33.

The context information processing block 33 operates an application by retrieving an optimized service, which is applicable in a present condition, according to a pre-received user preference, information of the context process information setting block 34 storing a limitation of a device for providing a service, and the context information such as the user position and a device condition obtained by questioning to the context awareness server in real-time.

The context process information setting block 34 stores user basic information such as the pre-received user preference and the limitation of the device for providing the service.

The sensor network managing block 35 guarantees reliability in operation by checking the condition of the sensors in consideration of a characteristic of the sensors, which are sensitive to power consumption.

The application block 36 operates an application program operated by each sensor node when providing a specific service by using sensor nodes.

Meanwhile, the context awareness server 30 stores the context information transmitted in real-time from the context awareness middleware 20, and provides basic information for retrieving the optimized service based on the context information. Herein, the provided basic information includes the position information of the user, temperature, and humidity as well as conditions of the user device such as a user preference with respect to the service request memory, bandwidth, and energy.

FIG. 4 is a block diagram illustrating a context awareness server of the context information providing service system based on a ubiquitous sensor network in accordance with an embodiment of the present invention.

As shown in FIG. 4, the context awareness server 30 of the context information providing service system based on a ubiquitous sensor network of the present invention includes a communicating block 41, a database (DB) managing block 42, and a context information DB 43.

The communicating block 41 receives the context information received in real-time through the context awareness middleware 20.

The DB managing block 42 stores the context information, which is received through the communicating block 41, in the context information DB 43 according to kinds of the context information, and performs functions retrieving, storing, and deleting the data from the context information DB 43.

The context information DB 43 stores and manages the context information according to a control of the DB managing block 42.

The context awareness server 30 can include a program supporting a web server function and code mobility. That is, the DB managing block 42 provides diverse context information providing services to the user by having a web server function.

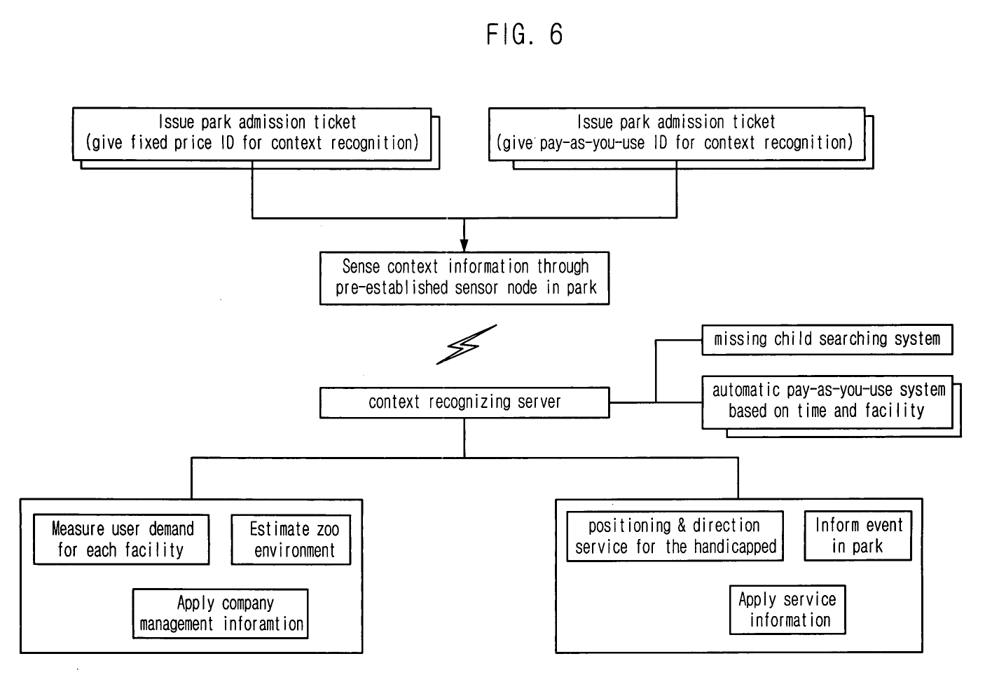

The detailed embodiment of the present invention will be described referring to FIG. 6.

FIG. 6 is a block diagram showing a context information providing service method based on a ubiquitous sensor network in accordance with an embodiment of the present invention, and the embodiment applied to a smart park will be described hereinafter.

It is assumed that the user is provided with service information such as missing child search, an automatic charge based on using time and using number, and a real-time event guidance in the park, while using an amusement facility of the park where a context information awareness system is set up.

First, a flat rate or pay-as-you-enjoy admission ticket with a tag-sensor 21, or a portable wireless guidance device such as a personal digital assistance (PDA) is issued to the user. A sensing-sensor 22 set up at the entrance of each amusement facility, a zoo, a bench, and a street light senses the position of the tag-sensor 21, and transmits the context information to the sink-sensor 23 through short-distance wireless communication, such as “RF”, “UWB”, and “Zigbee” in real-time.

Subsequently, the context awareness middleware 20 receiving the context information from the sink-sensor 23 analyzes the context information and requests the context awareness server 30 to store the context information.

Subsequently, the context awareness server 30 stores the context information of the user, which is collected in real-time through the context awareness middleware 20, in a context information database 33 managed by the context awareness server 30. As described above, the context awareness server 30 has a function of a web server which is accessible from the outside. For example, if there is a missing child and the child has a tag-sensor 21, the user can be provided with the position of the missing child through the web server.

Also, if a command for outputting an advertisement message or a speech message announcing the start of a specific event in the park is transmitted, the user can be informed of an event in progress in a specific place and the site of the event. It is also possible to generate an event by using a button or a speech recognition tool mounted in the PDA for a handicapped person. The event is used to provide a road guidance service based on the position stored in the context awareness server 30 through the sensor network.

Also, if a user with a park addimission ticket of pay-as-you-enjoy uses the amusement facility, the user can be provided with an automatic charging service when leaving the theme park, since an amusement facility usage history, such as ID, the kind of the amusement facility, and using number, is transmitted to the context awareness server 30 in real-time through the sensing-sensor 22 set up in the amusement facility.

Also, the context awareness server 30 can provide services such as measurement of user accommodation for each amusement facility and control of temperature and humidity through an environment measurement in the inside of a zoo through the sensor network.

The context information providing method based on the ubiquitous sensor network following the present invention will be described again as follows.

First, the sensing-sensor 22 senses a position of the tag-sensors 21 or collects the context information such as a climatic condition including temperature, humidity, and pressure. The collected context information is transmitted to the context awareness server 30 through the context awareness middleware 20. Subsequently, the context awareness server 30 provides a proper service according to context information retrieval of the user.

The context information providing service system based on a ubiquitous sensor network of the present invention recognizes the user position information and the environment information by using small sensor nodes having many sensors and a terminal of the user, and provides a proper service to the user terminal according to the recognized position information and environment information. Herein, the services such as a road guidance based on position information in the inside/outside, a lost and found information service, a missing child searching service can be provided to the user terminal.

As described above, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

The present invention can provide diverse and convenient services with minimum actions of the user by collecting real-time context information of the user through the sensor network and providing the optimized service to each user.

The present application contains subject matter related to Korean patent application No. 2004-0107231, filed with the Korean Intellectual Property Office on Dec. 16, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A context information providing service system based on a ubiquitous sensor network, comprising:
a sensing means for collecting context information of each user;
an intermediating means for changing the user context information transmitted from the sensing means into a request to store the request in a context recognizing means, transmitting the request to the context recognizing means, and transmitting a service request transmitted from the user to the context recognizing means; and
a context recognizing means for storing context information of each user according to a context information storing request transmitted from the intermediating means, and providing a relevant service by using the user context information that the context recognizing means stores according to the service request transmitted from the intermediating means.

2. The system as recited in claim 1, wherein the context information is information specifying an existence such as a person, a place, and an object, connected with an interaction between the user and the object, and includes resource information generated from a tool having calculation capability that the user uses, and peripheral information changed based on action of the user.

3. The system as recited in claim 2, wherein the sensing means includes:
a tag-sensor for sensing the context information of the user in real-time by being attached to the user or a device to provide a service;
a sensing-sensor for transmitting the context information of the user, which is collected by sensing signals from the tag-sensor, to the sink-sensor through a routing; and
a sink-sensor for collecting the context information of the user from the sensing-sensor, transmitting the context information to the intermediating means, and controlling the sensing-sensor.

4. The system as recited in claim 3, wherein radio frequency communication is used in the communication between the tag-sensor and the sensing-sensor.

5. The system as recited in claim 3, wherein Zigbee communication is used between the tag-sensor and the sensing-sensor.

6. The system as recited in claim 3, wherein ultrawideBand (UWB) communication is used between the tag-sensor and the sensing-sensor.

7. The system as recited in claim 3, wherein more than three sensing-sensors transmit own position information to the tag-sensor, and the tag-sensor transmits position coordinates calculated by using the position information transmitted from the more than three sensors in the step that the sensing-sensor collects the position information through the tag-sensor.

8. The system as recited in claim 3, wherein the sensing-sensor calculates the position from the signals transmitted from the tag-sensor in the step that the sensing-sensor collects the position information through the tag-sensor.

9. The system as recited in claim 2, wherein the intermediating means includes:
a communicating means for transmitting/receiving the sensing means, the context recognizing means, and data;
a context information managing means for transmitting the context information and a user service request, which are received through the communicating means, to the context recognizing means through the communicating means;
a managing means for guaranteeing confidence of operation by periodically inspecting the condition of the sensing means.

10. The system as recited in claim 9, wherein the intermediating means further includes:
an information setting block for storing pre-received user basic information;
a context information processing means for performing an optimized application according to the user basic information stored in the information setting means according to the user service request, which is received through the context information managing means, and the context information obtained by questioning to the context recognizing server in real-time; and
a performing means for storing a plurality of applications and performing a relevant application according to control of the context information processing means.

11. The system as recited in claim 9, wherein the communicating means prevents traffic congestion by setting up a time to live (TTL) value in a packet including the user context information transmitted from the sensing means.

12. The system as recited in claim 9, wherein the communicating means further performs an authentication function of a user service request transmitted from the sensing means.

13. The system as recited in claim 9, wherein the communicating means checks whether a result of the user service request transmitted from the sensing means is properly provided to the relevant user, and if the result comes out a failure, the communicating means performs a transmission function again.

14. The system as recited in claim 1, wherein the context recognizing means includes:
a communicating means for receiving the context information and the user service request, which are received in real-time through the intermediating means;
a database managing means for storing the context information received through the communicating means in a context information database by classifying according to kinds of the context information, and providing a user information providing service by retrieving, storing, removing the relevant data from the context information database according to the user service request received through the communicating means; and
a context information database for storing the context information according to the control of the database managing means.

15. A context information providing service based on a ubiquitous sensor network comprising the steps of:
a) collecting the context information of the user by using a ubiquitous network;
b) storing the context information according to each user; and
c) retrieving the context information of the user upon receipt of a service providing request from the user and providing a proper service.

16. The method as recited in the claim 15, wherein the context information is information specifying an existence connected with an interaction between the user and an object, and includes resource information generated from a tool having a calculation capability that a user uses and peripheral information changed based on an action of the user.
